(19) United States
(12) Patent Application Publication
(10) Pub. No.: US 2003/0218388 A1
(43) Pub. Date: Nov. 27, 2003

(54) Device for triggering an electric power component

(76) Inventors: Horst Lohmueller, Dusslingen (DE); Thomas Mager, Pfullingen (DE)

Correspondence Address: KENYON & KENYON, ONE BROADWAY, NEW YORK, NY, 10004, US

(21) Appl. No.: 10/329,118

(22) Filed: Dec. 24, 2002

(30) Foreign Application Priority Data
Dec. 29, 2001 (DE) 10164486.8

(51) Int. Cl. H02H 1/00

(52) U.S. Cl. 307/125

(57) ABSTRACT

In a device for triggering an electric power component, both open-loop voltage control or closed-loop voltage control, and open-loop current control or closed-loop current control of the switching output are provided for a switching operation of the power component.

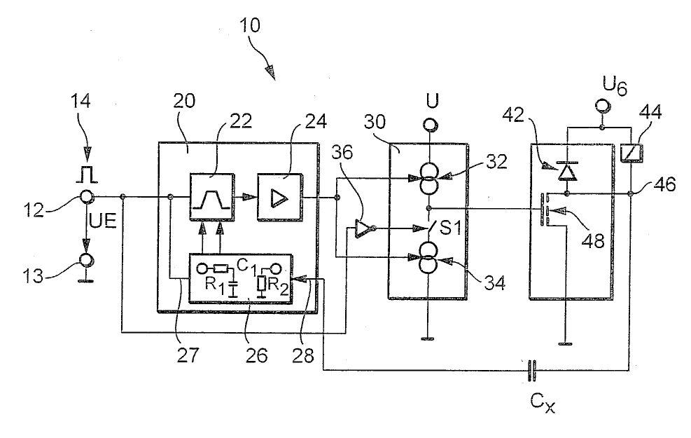

### BACKGROUND INFORMATION

Clocked systems are being increasingly used in circuit technology, in particular in the automotive industry, this development being particularly noticeable with highly integrated circuits. Such clocked systems are generally known, fixed switchable currents or voltages, or ramps, being provided for triggering power components. These clocked systems emit a larger amount of electromagnetic radiation, partly due to high energy levels or currents to be switched in particular, which results in problems for the electromagnetic compatibility (EMC) with other systems. In particular, the known clocked systems cause interference with other components in the cable harness, i.e., the vehicle's electrical system. In particular interference with the radio receiver is to be emphasized in this case.

### SUMMARY OF THE INVENTION

The present invention has the advantage over the related art that electromagnetic compatibility is enhanced, i.e., electromagnetic radiation from electrical power components triggered using the device according to the present invention is reduced. This is the case in particular of electronic switches in clocked systems. The functional reliability of other electric components and systems which are physically close to the electric power component is thus considerably enhanced.

It is particularly advantageous that two power sources are provided, which are controlled via a U/I converter, the U/I converter having a timing unit, the performance characteristics of the timing unit being determined either by an internal timer or by a feed-back path of the switching output. This makes it possible to provide either pure open-loop control of the power component's switching output by using the internal timer, or closed-loop regulation by using the feed-back path of the switching output.

It is furthermore advantageous for the device according to the present invention to have a monolithically integrated design, which allows the device to be manufactured in particular very cost-effectively and to exhibit greater functional reliability.

### BRIEF DESCRIPTION OF THE DRAWING

The FIGURE shows a block diagram of the device according to the present invention for triggering an electric power component.

### DETAILED DESCRIPTION

The FIGURE shows a block diagram of a device 10 according to the present invention for triggering a power component. Device 10 includes a first circuit block 20 and a second circuit block 30. The first circuit block has an input 12, which is at a clocked, i.e., pulsed, voltage level UE with respect to ground potential 13. The fact that input 12 of first circuit block 20 is clocked is illustrated by a clocking pulse 14.

First circuit block 20 has, in addition to input 12, a voltage/current converter, i.e., U/I converter 22, which is connected to input 12. Furthermore, first circuit block 20 has an amplifier 24, whose input is connected to the output of U/I converter 22. Furthermore, first circuit block 20 has a timing unit 26, which has a first input 27 and a second input 28. First input 27 of timing unit 26 is connected to input 12. Timing unit 26 has furthermore one or more outputs, which control the U/I converter. These outputs are represented in the FIGURE by arrows provided between timing unit 26 and U/I converter 22. Timing unit 26 has an internal timer, which includes a first resistor R1 and a first capacitor C1 for determining a time constant. In addition, timing unit 26 has a second resistor R2, which cooperates with a second capacitor Cx to be described later.

Second circuit block 30 has a first controllable power source 32 and a second controllable power source 34, which are connected in series between a voltage U and the ground potential, a controllable switch S1, capable of interrupting the series circuit of power sources 32, 34, being connected between power sources 32, 34. First power source 32 is provided between switch S1 and voltage U, and second power source 34 is provided between switch S1 and the ground potential. The control inputs of both controllable power sources 32, 34 are connected to the output of amplifier 24 for their control by first circuit block 20.

The control input (not provided with a reference symbol) of controllable switch S1 is connected to input 12 via a device 36 in the example shown. Device 36 is an amplifier having an inverting input. When voltage level UE is “zero” or “low,” switch S1 is closed. When voltage level UE is “high,” switch S1 is open. A tap which is connected to the control input of an electric power component 48, in particular a D-MOS power output stage, is provided, according to the present invention, between first power source 32 and switch S1. The first power terminal of power component 48, henceforward referred to as source terminal, is connected to ground potential, and its second power terminal 46, henceforward referred to as drain, is connected to a supply voltage U_{b} via a diode 42. A load 44 is connected between second power terminal 46 and supply voltage U_{b}, in parallel to diode 42. Second power terminal 46 is henceforward referred to as switching output 46 of power component 48. In the case of an inductive load 44, diode 42 makes it possible for the previously impressed current to continue to flow back to the terminal of supply voltage U_{b} for some time immediately after the power component has been switched off as long as the previously impressed current still flows through, inductive load 44.

In an advantageous embodiment of the present invention, switching output 46 is connected to second input 28 of timing unit 26 via second capacitor Cx.

The device according to the present invention for triggering power components, in particular semiconductor elements in the form of power transistors having voltage-controlled power sources, makes it possible for simultaneously adjustable current control of power component 48 to be performed independently of the load connected, in addition to the known ramp-shaped voltage control of switching output 46. The load jump at switching output 46 of power component 48 is thus voltage-controlled and current-controlled via open-loop control or closed-loop regulation, resulting in minimum EMC interference.

The device according to the present invention operates so that a trigger signal, represented by timing pulse 14, of voltage UE, i.e., a flank change, initiates the charging or discharging sequence of first power source 32 and second power source 34 at input 12 of first circuit block 20 via switch S1. The charging sequence is initiated with UE at “high.” The input of power switch 48, i.e., power component 48, is now acted upon by first power source 32 and thus turned on, and current is applied to load 44 toward the ground potential. It is important here that the absolute value of the power from first power source 32 is less than that from second power source 34. A ratio, however, is settable according to the present invention. The discharge sequence is initiated with UE on “low” level. Since the power from second power source 34 is greater than that from first power source 32, the power requirement of second power source 34 is covered from both first power source 32 and the input of power switch 48, i.e., power component 48. As a result, power switch 48 is blocked and thus the current is unable to flow through load 44 toward the ground potential, but toward power supply U_{b}. Simultaneously with the charging/discharging sequence, U/I converter 22 is started and triggers power component 48 via amplifier 24 and controllable power sources 32, 34 by open-loop voltage and current control or by closed-loop voltage and current regulation.

U/I converter 22 may be timed using timing unit 26 according to the present invention either via the internal timer, which includes first resistor R1 and first capacitor C1, in which case pure open-loop control of switching output 46 is achieved, or via second resistor R2 and second capacitor Cx, i.e., by the feed-back path from switching output 46 to timing unit 26, in which case closed-loop regulation results. The selection of either option is defined by the selected application or the degree of integration; switching between both options may also be provided.

What is claimed is:

1. A device for triggering an electric power component, the power component including a switching output, the device comprising:
an arrangement for providing, for a switching operation of the power component, both (a) at least one of an open-loop voltage control and a closed-loop voltage control of the switching output, and (b) at least one of an open-loop current control and a closed-loop current control of the switching output.

2. The device according to claim 1, wherein the power component is a D-MOS power output stage.

3. The device according to claim 1, further comprising two controllable power sources for controlling a control input of the power component.

4. The device according to claim 3, further comprising a U/I converter for controlling the power sources, the U/I converter including a timing unit, performance characteristics of the timing unit being determined by one of an internal timer and a feed-back path of the switching output.

5. The device according to claim 1, wherein the device is monolithically integrated.
